(19) United States
(12) Patent Application Publication
(10) Pub. No.: US 2007/0154327 A1
(43) Pub. Date: Jul. 5, 2007

(54) Controllable capillary pump

(75) Inventors: Chia-Hung Liu, Chutung (TW); Ming-Tsang Lee, Berkeley, CA (US); Ralph Greif, Berkeley, CA (US); Costas P. Grigoropoulos, Berkeley, CA (US); Hyung Gyu Park, Berkeley, CA (US); Frank K. Hsu, Berkeley, CA (US); Chun-Hung Lin, Chutung (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu Hsien (TW)

(21) Appl. No.: 11/320,816

(22) Filed: Dec. 30, 2005

(51) Int. Cl. F04B 19/24; F15C 1/06

(52) U.S. Cl. 417/208; 137/833

(57) ABSTRACT

A controllable capillary pump utilizing groupings of capillary tubes. Since individual capillary tubes produce different flow rates depending on their diameter, length and cross-sectional shape, it is possible to control the flow rate by providing different groups of capillary tubes. These groups may be included on a rotating cylinder so that a selection may be made merely by rotating the cylinder.

### BACKGROUND OF THE INVENTION

1. Field of the Invention

The present invention relates generally to a capillary pump and more particularly to a controllable capillary pump having a variable number and variable size or shape of tubes to control the flow.

2. Description of the Related Art

In many types of processes, it is necessary to have flow delivery systems for the various components of the reactions. Typically, it is necessary to not only deliver the flow of material, but also to be able to control the flow so that the proper mix of materials can be introduced into the reaction. In order to accomplish this, traditional flow systems used pumps, valves, connectors, controllers and other hardware in order to both move the material and to control the flow.

While such systems are readily workable for large scale reactions such as a chemical plant, in a number of cases, the apparatus is of much smaller scale and the use of a variety of hardware items to control the flow is not preferred since it increases the size, weight and complexity of the system. One such system which avoids the need for large amounts of hardware is a capillary pump. These systems use capillary forces to move the materials.

One such capillary pump is described in U.S. Pat. No. 6,634,864. This device provides a capillary pump for producing pressurized vapor emissions and has various layers that assist in creating conditions to accomplish a high fluid flow rate and pressurization. In particular, the device involves four layers which provide different functions. A coating is provided to at least partially surround the outer surfaces of the pump to allow vapor pressure to increase. However, this system utilizes heating and cooling to drive the fluid in a closed system. Several pore layers are required to separate liquid from the vapor. Thus, this type of system requires heating and a number of layers of materials in order to cause the capillary pumping action.

An article in the Journal of Power Sources (Vol. 132, p. 8691, 2004) entitled “Passive Fuel Delivery System for Portable Direct Methanol Fuel Cells”, by Guo and Cao also teaches the use of a capillary pump. Fuel delivery is accomplished using a concentration/density difference for the fuel delivery. In particular, this system utilizes a wick material in order to move the methanol.

While such arrangements may be useful in some situations, it is difficult to accurately control the pumping action and it requires certain specialized layers or wicks for delivering the material. It is desirable to provide simpler systems which are easily controllable in a simple manner.

### SUMMARY OF THE INVENTION

Accordingly, the present invention provides a capillary pump which is controllable.

Further, the present invention provides a capillary pumping device which does not use porous medium material.

Furthermore, the present invention provides a capillary pump arrangement using a plurality of capillary tubes to control the flow.

The present invention still further provides a pumping device which is easily controlled to adjust the flow of material by using capillary tubes having different diameters, shapes and lengths.

The present invention further provides a capillary pumping device used in conjunction with a fuel cell for providing fuel thereto.

The present invention still further provides a method for controlling the flow of a pumped fluid.

Still further, the present invention provides a controllable pumping device by providing a plurality of sets of capillary tubes with each set having a different flow characteristic.

The present invention still further provides a controllable capillary pump having a rotatable cylinder with a plurality of sets of capillary tubes so that the flow is controllable by rotating the cylinder.

The present invention achieves all this by providing capillary tubes which can be varied in cross-section, length, diameter, and cross section along its length and in other manners in order to produce different flow rates to a reaction device, such as a fuel cell. It is noted that the cross-section of the capillary can vary along its length.

### BRIEF DESCRIPTION OF THE DRAWINGS

A more complete appreciation of the present invention and many of the attendant advantages thereof will be readily appreciated as the same becomes better understood by reference to the following detailed description when considered in connection with the accompanying drawings, wherein:

FIG. 1 is a schematic diagram of the present invention;

FIG. 2 is a graph of measured temperature and measured flow rate for tubes having a diameter of 300 μm;

FIG. 3 is a graph of measured temperature and measured flow rate for tubes having a diameter of 500 μm;

FIG. 4 is a cross-sectional view of a capillary pump according to the present invention;

FIG. 5 is a perspective view of a capillary pump according to the present invention.

### DESCRIPTION OF THE PREFERRED EMBODIMENT

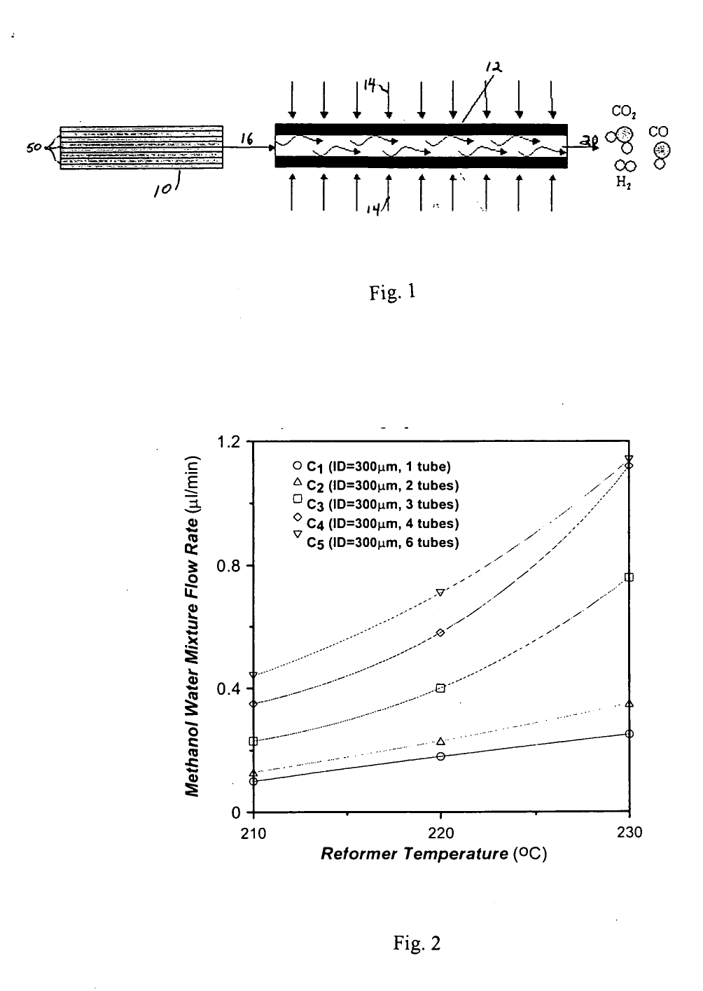

Reference will now be made in detail to the preferred embodiment of the present invention, examples of which are illustrated in the accompanying drawings. FIG. 1 shows an arrangement of a capillary pump 10 and a fuel cell reformer 12. The capillary pump 10 is configured with a group of capillary tubes 50. The capillary tubes utilized can be made of any material which is not affected by the liquid mixture. Thus, the tubes can be made of glass, metal, Teflon, plastic materials or insulated materials. The fuel cell may be a proton exchange membrane fuel cell or any other type of fuel cell or even other reactors which require a flow of a fluid material. The fuel for the fuel cell is typically a mixture of liquid such as methanol (CH₃OH) and water (H₂O). Experiments were carried out in a mole concentration ratio of 1:1.1 for methanol:water. The mixture 16 is pumped by the capillary pump into the fuel cell reformer 12. At the same time, heat 14 is also applied to the reformer from the outside. The products 20 of the reformer include CO, CO₂ and H₂. The hydrogen from these products can then be used in the fuel cell itself. The reformer may also include a catalyst to aid the reaction.

The capillary tubes 50 act to pump the liquid due to capillary action. By using hollow tubes, rather than porous medium materials such as silica wool or glass fiber, the capillary tube has minimal blockage and accordingly a much smaller pressure drop along the length of the tube, compared to prior art devices. Further, there is no problem concerning the degradation of the porous material. It has also been discovered that different flow rates can be obtained by varying several parameters of the capillary tubes. The flow rate is affected by the diameter of the tube, the cross-sectional shape, the length and variations in cross-sections along the length. In addition, the total flow rate can be changed by using more than one tube at a time.

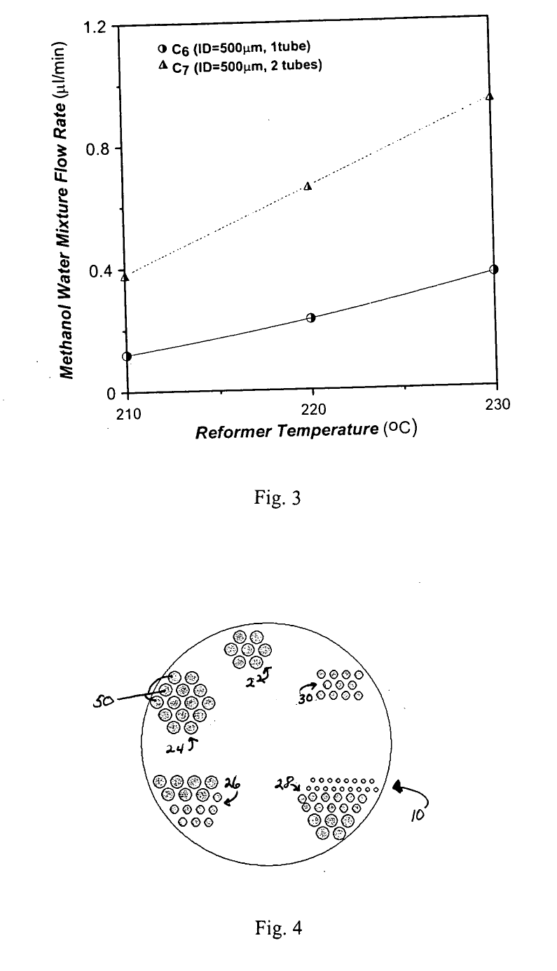

FIGS. 2 and 3 are graphs which show the measured flow rates of the methanol water mixture for tubes having specific diameters. In FIG. 2, the diameter of the tube is 300 μm. In FIG. 3, the diameter is 500 μm. In addition, FIG. 2 shows not only the flow rate for a single tube but also for groupings of 2, 3, 4 and 6 tubes. Likewise, FIG. 3 shows a single tube or a grouping of 2 tubes. In addition, results are shown for three different temperatures of the reformer. In the tests involved in both of these figures, the tubes have the same length, 20 mm. In general, the results show that increasing the number of capillary tubes increases the flow rate. Also, by comparing FIGS. 2 and 3, it can be seen that one tube having a diameter of 500 μm produces similar flow rates to 2 tubes of 300 μm.

Thus, the results indicate that the flow rate depends at least on the diameter and the number of tubes used. Similarly, by varying the diameters, lengths, and cross-sectional shapes, different flow rates can be obtained. The results shown in FIGS. 2 and 3 were obtained using only capillary pumping. As a result, no power and no complex elements are involved and the apparatus is quiet, has low cost and high reliability.

Furthermore, it is possible to control the flow rate by varying the parameters of the capillary tubes in the capillary pump. Thus, a grouping of specific sizes and shapes can produce a specific flow rate for a pump. If a system requires a higher or lower flow rate, some of the capillary tubes can be removed or replaced with other tubes having different parameters, such as a different diameter or different shape.

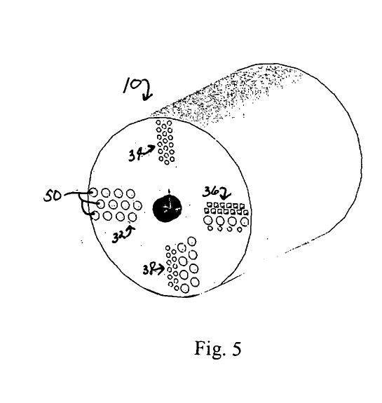

FIG. 4 shows an example of a cross-section of a controllable capillary pump. Likewise, FIG. 5 shows a cylinder used in a similar controllable capillary pump. The pump 10 includes different groupings of tubes 50 with the groups indicated as 22, 24, 26, 28 and 30 in FIG. 4 and 32, 34, 36 and 38 in FIG. 5. As can be seen, the tubes in each grouping may be similar sized or a mixture of two or more sizes. Likewise, the tubes in any grouping may have the same shape or different shapes. The important thing is that the total flow rate for the grouping is a desired value. By having groups with different flow rates, it is possible to adjust the flow rate to the reactor as desired.

The selection of the appropriate flow rate may be accomplished by merely rotating the cylinder 10 so that the desired grouping is aligned with the source of the liquid mixture and the reformer. Thus, the cylinder could contain markings associated with each grouping to indicate the flow rate for that grouping so that the user can easily adjust the cylinder to a flow rate which is desired.

It should be remembered that the capillary pump described above has been indicated as providing a liquid mixture to a fuel cell. However, the capillary pump may be used in many other applications, including electronic cooling, micro-fuel cells, drug delivery systems or any other system which requires the delivery and control of a specific flow rate of a liquid.

It should further be noted that the present invention provides the capillary pumping utilizing an extremely simple arrangement and does not require a vaporization or pressurization of liquid, nor does it require various layers of materials. There is also no requirement for a concentration or density difference as is required in some of the prior art.

As noted above, it is not necessary to have any additional pump beyond the capillary pump itself. Accordingly, no extra power is required. However, it would be possible under some circumstances to also have a preliminary pump to help supply the liquid mixture to the capillary pump where it is then controlled.

It should also be remembered that the present invention is very simple and portable and can be produced at a very low cost. There are no moving parts, allowing for greater reliability. The flow rate of the pump can be controlled by using a different grouping of capillary tubes. Very low flow resistance occurs in this arrangement.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall with the metes and bounds of the claims, or equivalence of such metes and bounds are therefore intended to be embraced by the appended claims.

What is claimed:

1. A method of controlling a flow rate, comprising the steps of:
providing a plurality of groups of capillary tubes, each group having a flow rate different from other groups;
selecting one of the groups which has a desired flow rate.

2. The method according to claim 1, wherein the capillary tubes have various parameters for determining individual tube flow rates.

3. The method according to claim 1, wherein the method is used to pump a liquid to a reformer of a fuel cell.

4. A method of controlling a flow rate comprising the steps of:
providing a plurality of capillary tubes;
selecting a group of capillary tubes having a desired total flow rate.

5. A flow rate controller, comprising:
a plurality of capillary tubes;
said plurality of capillary tubes being grouped into a plurality of groups;
each group having a different total flow rate.

6. The controller according to claim 5, wherein the flow rate of individual capillary tubes is determined by the diameter of the tube, the length of the tube and the cross-sectional shape of the tube.

7. The controller according to claim 5, wherein the groups of capillary tubes are arranged in a rotating cylinder so that a specific group can be selected by rotating the cylinder to an appropriate position.

8. The controller according to claim 7, wherein the position is that which allows liquid to flow from a liquid source to a fuel cell.

9. A capillary pump, comprising:
a plurality of capillary tubes, each of said tubes having a flow rate depending on the diameter of the tube, the length of the tube and the cross-sectional geometry of the tube;
said tubes being arranged in groups with different groups having different total flow rates;
the flow rate of said pump being controlled by selecting different groups of capillary tubes.

10. The capillary pump according to claim 9, wherein the pump provides a flow of liquid to a fuel cell, an electronic cooling device, a micro-fuel cell, or a drug delivery system at a controlled flow rate.

11. The pump according to claim 9, wherein the tubes are made of one of glass, metal, Teflon, plastic and insulated material.

12. The pump according to claim 9, wherein the liquid is a mixture of methanol and water.
